(19) United States
(12) Patent Application Publication
(10) Pub. No.: US 2021/0352124 A1
(43) Pub. Date: Nov. 11, 2021

(54) CUSTOM GENERATED REAL-TIME MEDIA ON DEMAND

(71) Applicants: Russell Dean Lecamus, Spring, TX (US); Basil M. Angelo, Spring, TX (US)

(72) Inventors: Russell Dean Lecamus, Spring, TX (US); Basil M. Angelo, Spring, TX (US)

(21) Appl. No.: 17/382,962

(22) Filed: Jul. 22, 2021

Related U.S. Application Data
(63) Continuation of application No. PCT/US2020/015263, filed on Jan. 27, 2020.
(60) Provisional application No. 62/797,699, filed on Jan. 28, 2019.

(51) Int. Cl. H04L 29/06; H04N 21/258; G06F 16/787; G06F 16/587; H04W 4/02

(52) U.S. Cl. CPC H04L 65/4084; H04N 21/25841; H04W 4/025; G06F 16/587; G06F 16/787

(57) ABSTRACT

A method of generating custom real-time media on demand includes receiving a request for custom media to be generated at or near a service location from a media requestor, determining available media providers located at or near the service location, providing the media requestor information corresponding to the available media providers at or near the service location, receiving the media requestor's selection of a media provider from the available media providers, and facilitating provision of the custom media from the selected media provider to the media requestor.

### CROSS-REFERENCE TO RELATED APPLICATIONS

This application is a continuation of PCT International Application PCT/US2020/015263, filed on Jan. 27, 2020, which claims the benefit of, or priority to, U.S. Provisional Patent Application Ser. No. 62/797,699, filed on Jan. 28, 2019, all of which are hereby incorporated by reference in their entirety for all purposes.

### BACKGROUND OF THE INVENTION

Traditional media includes television, radio, and print media that are characterized by the one-way broadcast of content to a wide audience. New media is distinguished by digital content and the interactive nature of engagement with the medium. New media includes, for example, social media, blogs, vlogs, podcasts, streaming, and other Internet or network enabled content. From a production standpoint, both traditional and new media require digital media, or content, for use in their respective publications or applications. Digital media includes video, audio, and photographic image content that is provided in a digital file format capable of being streamed over a network connection. The digital media may be encoded in file format suitably specified for transmission within the available bandwidth, transcoded from the original file format to another that is more suitable for transmission, or transmitted using adaptive bit-rate streaming technology that dynamically adjusts the quality of the media based on the available bandwidth and real-time network conditions.

For purposes of illustration, video media is encoded in a standard or proprietary file format and is specified by a resolution and a frame rate. For example, 4K video media may be encoded in H.264 file format at a resolution of 4096 pixels×2160 pixels and 30 frames-per-second. Similarly, audio media is encoded in a standard or proprietary file format and is specified by a bit depth and a sample frequency. For example, uncompressed audio media may be encoded in PCM file format at 24 bits-per-sample and 96 KHz sample frequency. Photographic image media is also encoded in a standard or proprietary file format and is specified by a resolution and a color depth. For example, a high resolution photographic image taken with an Apple® smartphone may be encoded in, for example, HEIC file format at a resolution of 4000 pixels×3000 pixels and a 16 bits-per-pixel.

Traditional and new media outlets obtain digital media or content from in-house personnel, contractors, syndication, or independent media agencies that aggregate and license media. With respect to licenses, independent media agencies typically distinguish between editorial and commercial use, where editorial use is limited to non-commercial and news-related use and commercial use may be used to promote commercial interests. Independent media agencies typically aggregate digital media and provide prospective customers with a web-based portal through which they can search and license specific digital media from the archives for their desired use. Independent media agencies include, for example, Getty Images®, ShutterStock®, Fotolia®, and DepositPhotos®.

### BRIEF SUMMARY OF THE INVENTION

According to one aspect of one or more embodiments of the present invention, a method of generating custom real-time media on demand includes receiving a request for custom media to be generated at or near a service location from a media requestor, determining available media providers located at or near the service location, providing the media requestor information corresponding to the available media providers at or near the service location, receiving the media requestor's selection of a media provider from the available media providers, and facilitating provision of the custom media from the selected media provider to the media requestor.

According to one aspect of one or more embodiments of the present invention, a non-transitory computer readable medium comprising software instructions that, when executed by a processor, perform a method of generating custom real-time media on demand includes receiving a request for custom media to be generated at or near a service location from a media requestor, determining available media providers located at or near the service location, providing the media requestor information corresponding to the available media providers at or near the service location, receiving the media requestor's selection of a media provider from the available media providers, and facilitating provision of the custom media from the selected media provider to the media requestor.

Other aspects of the present invention will be apparent from the following description and claims.

### BRIEF DESCRIPTION OF THE DRAWINGS

FIG. 1 shows a block diagram of system for generating custom real-time media on demand in accordance with one or more embodiments of the present invention.

FIG. 2A shows a graphical user interface of a client-side software application, or web-based portal thereof, for identifying a service location of interest in accordance with one or more embodiments of the present invention.

FIG. 2B shows a graphical user interface of a client-side software application, or web-based portal thereof, for selecting a specific media provider located at or near a service location of interest in accordance with one or more embodiments of the present invention.

FIG. 2C shows a graphical user interface of a client-side software application, or web-based portal thereof, for reviewing detailed information about the selected media provider in accordance with one or more embodiments of the present invention.

FIG. 2D shows a graphical user interface of a client-side software application, or web-based portal thereof, for allocating rights in accordance with one or more embodiments of the present invention.

FIG. 2E shows a graphical user interface of a client-side software application, or web-based portal thereof, for engaging the selected media provider in accordance with one or more embodiments of the present invention.

FIG. 2F shows a graphical user interface of a provider-side software application, or web-based portal thereof, for reviewing an assignment request and confirming the engagement in accordance with one or more embodiments of the present invention.

FIG. 2G shows a graphical user interface of a client-side software application, or web-based portal thereof, for confirming the selected media provider's acceptance of the assignment in accordance with one or more embodiments of the present invention.

FIG. 2H shows a simplified block diagram of a system for generating custom real-time media on demand where the selected media provider provides the requested custom media to the media requestor in real-time in accordance with one or more embodiments of the present invention.

FIG. 3 shows a block diagram of a server-side software application in accordance with one or more embodiments of the present invention.

FIG. 4 shows a block diagram of an exemplary computing system in accordance with one or more embodiments of the present invention.

FIG. 5 shows a block diagram of an exemplary smartphone in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention. For the purpose of this disclosure, real-time means at or very near real time delayed by generation, transcoding, if any, and transmission of media only.

The compelling solutions offered by syndication and independent media agencies has increased the media's reliance on independent third-parties to provide substantially all of the digital media, both editorial and creative, that they require. However, this reliance has exposed a number of shortcomings in conventional models of syndication and licensing. For example, there is no guarantee that desired media will be generated and made available for license, there is no opportunity to influence or control production, and the non-exclusive license typically offered means potential competitors may obtain and use the same media, eviscerating the ability to use exclusive content. While some independent media agencies offer customized media upon request, they require significant planning well in advance and lack immediacy as the results are provided after the fact. Historically, traditional media outlets had the advantage of having dedicated personnel capable of going on site to generate desired content when there was breaking news. However, they cannot respond at a moment's notice and they simply cannot be everywhere at once.

Accordingly, in one or more embodiments of the present invention, a method of generating custom real-time media provides real-time access to media providers around the world that are capable of providing custom media on demand. A media requestor may request custom media to be generated at or near a service location of interest anywhere in the world. Available media providers located at or near the service location of interest may be identified and the media requestor may select a media provider to generate the custom real-time media. The method facilitates the direct or indirect provision of the requested custom media from the selected media provider to the media requestor in real-time. The media requestor may influence or control the production of the requested custom media while it is being generated and transmitted. Advantageously, the media requestor has access to a large number of readily available media providers practically all over the world capable of generating custom media on demand in real-time. Additionally, the method provides a mechanism to bring unknown parties together, allocate rights between the parties, facilitate a transaction, and monetize citizen journalism.

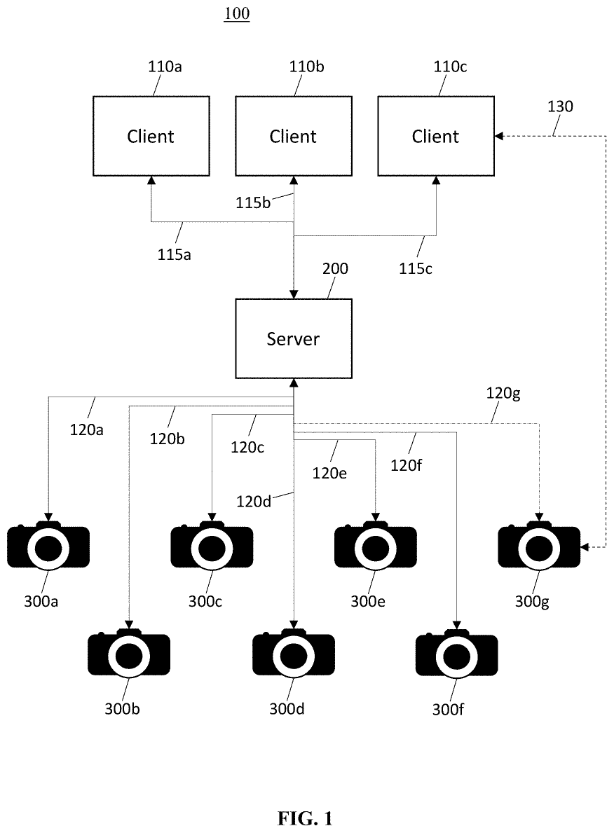

FIG. 1 shows a block diagram of system 100 for generating custom real-time media on demand in accordance with one or more embodiments of the present invention. System 100 may include, as the central hub, one or more computing resources, or servers, 200, that execute a server-side software application (not independently shown) for generating custom real-time media on demand. The one or more computing resources, or servers, 200, may be a discrete computing system, a plurality of distributed computing resources, or an on-demand cloud computing platform, such as, for example, Amazon Web Services®, Microsoft Azure®, or Google Cloud Services® that provides scalable resources on demand. System 100 may also include a client-side software application (not independently illustrated), or web-based portal thereof, and a provider-side software application (not independently illustrated), or web-based portal thereof, that interface with the server-side software application, and in some embodiments with each other, to facilitate the provision of custom real-time media (not shown) from a selected media provider to a media requestor.

For purposes of illustration, each media provider may execute the provider-side software application, or browse the web-based portal thereof, on the media provider's computing system (e.g., 300a-300g), which may be a smartphone (not shown). The media provider may log into their account with the server-side software application over a network connection (e.g., 120a-120g) and provide the server-side software application with information including, for example, their current location, availability to generate media, and on-hand equipment. Each media requestor, or client, may execute a client-side software application, or browse the web-based portal thereof, on the media requestor's computing system (e.g., 110a-110c), which may be a smartphone (not shown). Each media requestor requesting custom media may transmit over a network connection (e.g., 115a-115c), from the client-side software application, or web-based portal thereof, to the server-side software application, a service location of interest, anywhere in the world, where they would like custom media to be generated in real-time.

The server-side application may identify available media providers located at or near the service location of interest and provide (e.g., 115a-115c) the client-side software application, or web-based portal thereof, with information relating to one or more available media providers. The client-side software application, or web-based portal thereof, may provide a graphical user interface (not shown) that shows available media providers' actual locations on a map that includes the service location of interest. The media requestor may browse the map and receive detailed information about one or more of the available media providers including, for example, their current location, availability to generate media, on-hand equipment, and optionally licensing terms and samples of their portfolio. The media requestor may select an available media requestor to generate the requested custom media and the server-side software application may facilitate the provision of the custom media from the selected media provider to the media requestor. In certain embodiments, the custom media may be provided from the selected media provider to the media requestor directly via a sideband peer-to-peer network connection 130. In other embodiments, the custom media may be provided from the selected media provider to the media requestor indirectly via server 200. Advantageously, at any given time, a media requestor may login to the system, identify a service location of interest, and request custom real-time media be generated by one or more available media providers already located at or near the service location.

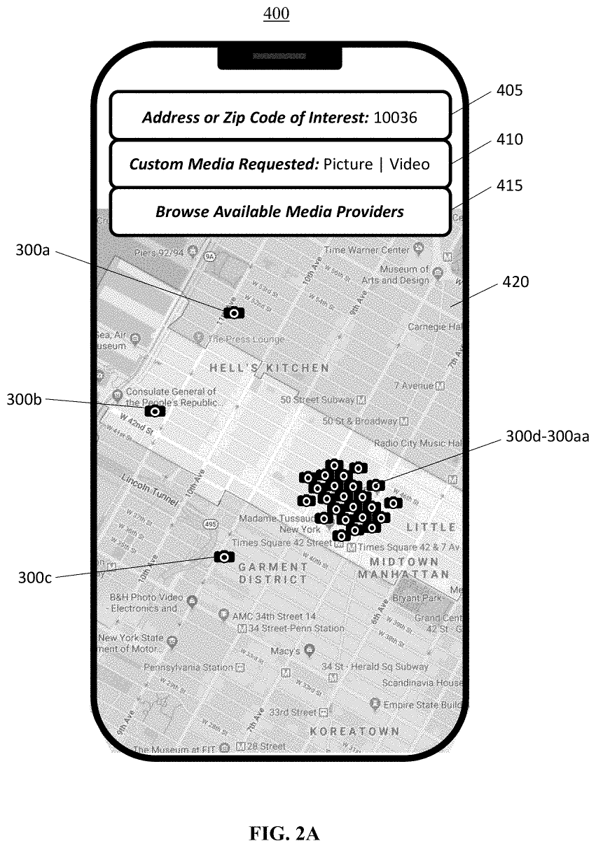

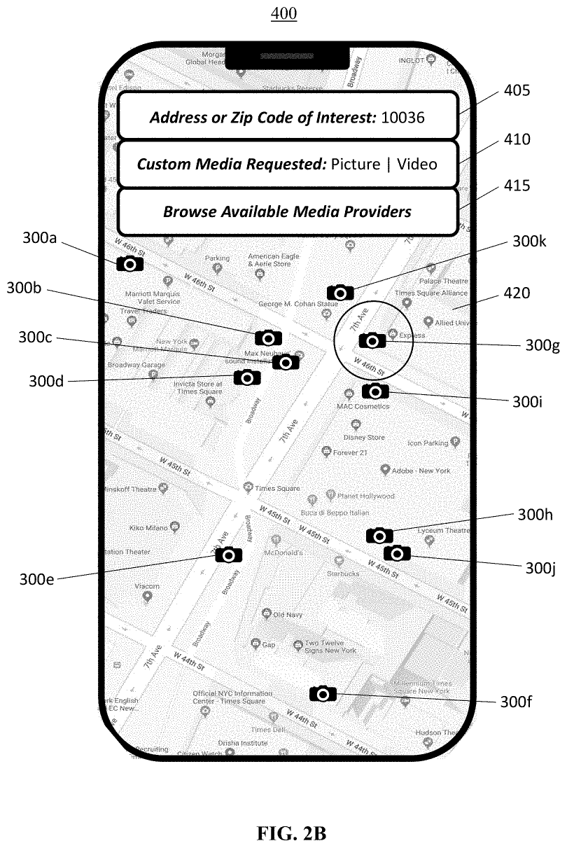

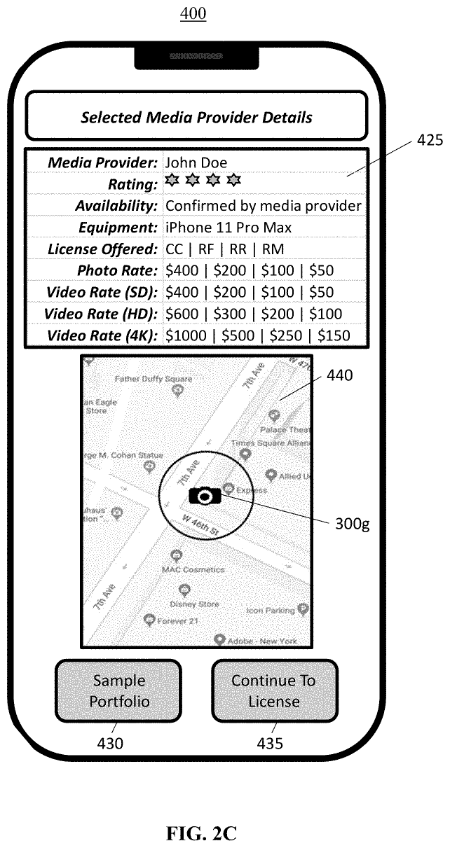

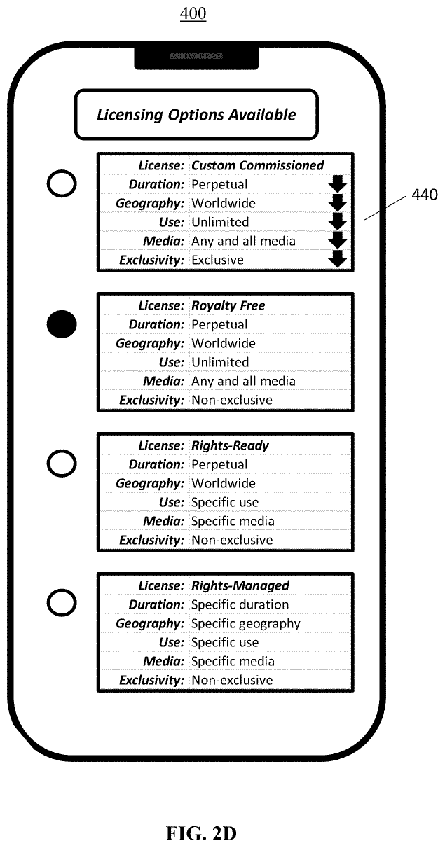

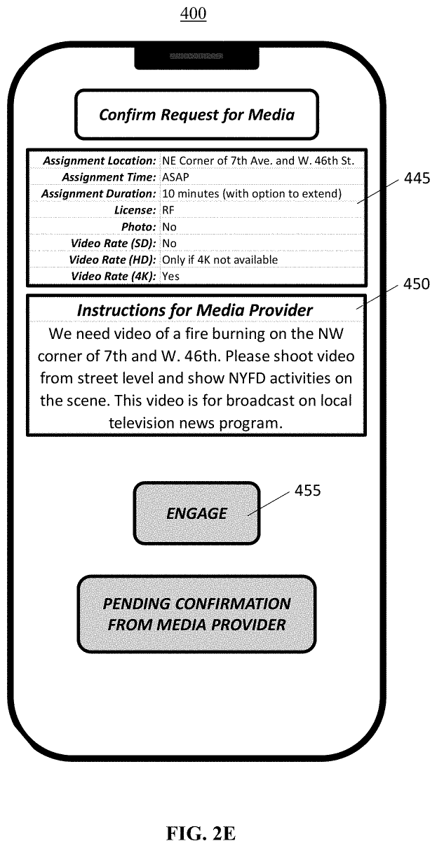

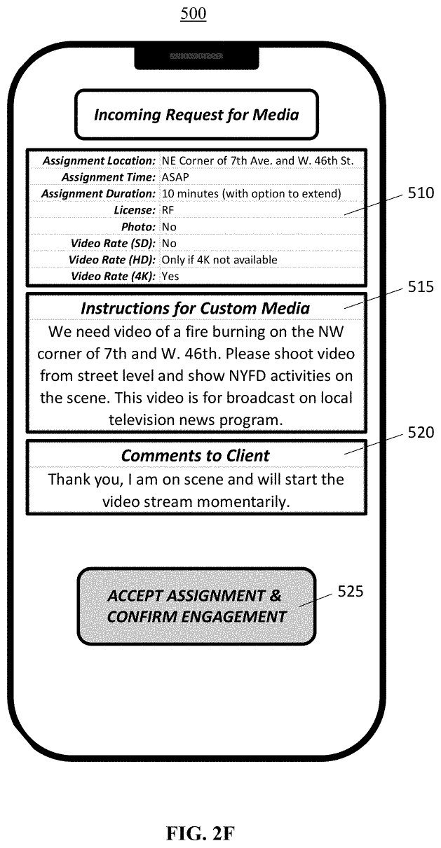

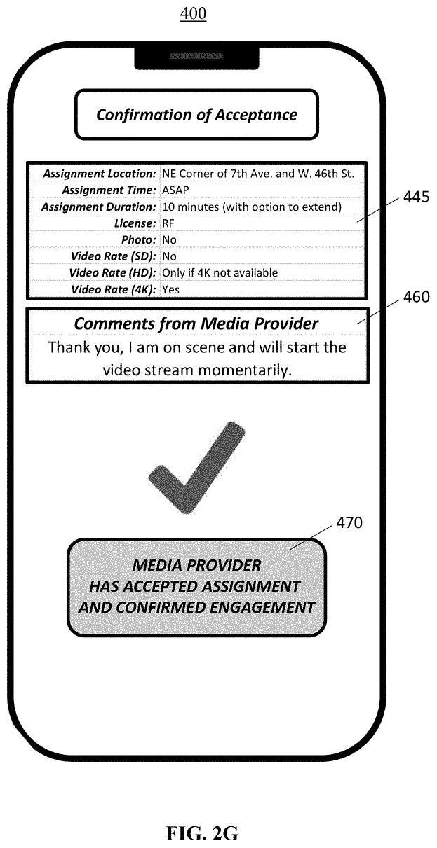

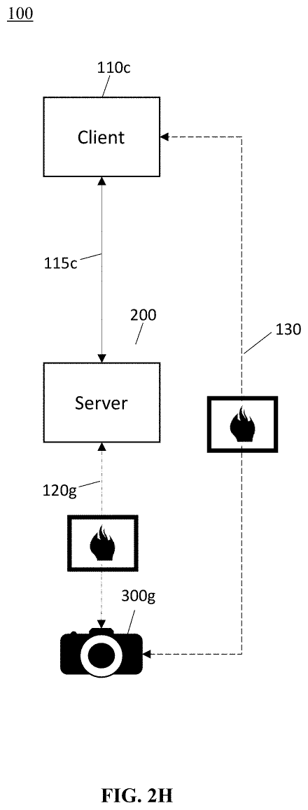

FIG. 2A shows a graphical user interface of a client-side software application, or web-based portal thereof, 400 for identifying a service location of interest in accordance with one or more embodiments of the present invention. A media requestor may launch the client-side software application, or browse the web-based portal thereof, 400 that provides a map-based 420 graphical user interface. The media requestor may provide identifying information 405 corresponding to the service location of interest including, for example, one or more of an address, an intersection, a zip code, a point of interest, GPS coordinates, or latitude and longitude and optionally a distance therefrom, such as, for example, a 5 mile radius. The media requestor may also identify the type or kind 410 of custom media they desire to be generated such as, for example, video, audio, or photographic media. Optionally, the media requestor may also specify technical specifications of the custom media desired. Once the request has been lodged, the server-side software application (not shown) may determine the available media providers 300a-300aa currently located at or near the service location of interest and provide the client-side software application, or web-based portal thereof, 400 information corresponding to the available media providers 300a-300aa currently located at or near the service location. The client-side software application, or web-based portal thereof, 400 may display icons representing the current locations of available media providers at or near the service location of interest.

Continuing, FIG. 2B shows a graphical user interface of a client-side software application, or web-based portal thereof, 400, for selecting a specific media provider (e.g., 300g) in accordance with one or more embodiments of the present invention. The media requestor may browse the map (e.g., dragging, zooming in, or zooming out) to narrow focus and identify one or more available media providers 300 currently located at or near the service location of interest. The media requestor may select a specific media provider (e.g., 300g) from the available media providers 300. Continuing, FIG. 2C shows a graphical user interface of a client-side software application, or web-based portal thereof, 400, for reviewing detailed information about the selected media provider in accordance with one or more embodiments of the present invention. The client-side software application, or web-based portal thereof, 400 may display detailed information corresponding to the selected media provider 300g including, for example, one or more of a name, rating, availability, on-hand equipment, media generation capabilities, license terms, and pricing information. In some embodiments, the detailed information corresponding to the selected media provider 300g may optionally include a sample portfolio 430 of the media provider's work so the media requestor may vet the selected media providers work product. If the media requestor wishes to continue with the selected media provider 300g, the media provider may proceed 435 to the allocation of rights for the custom media to be generated.

Continuing, FIG. 2D shows a graphical user interface of a client-side software application, or web-based portal thereof, 400, for allocating rights 440 in accordance with one or more embodiments of the present invention. In certain embodiments, the selected media provider may provide the server-side software application with one or more predetermined licensing options in advance. When a particular media provider is selected, the server-side software application may provide the client-side software application with the predetermined licensing options offered by the selected media provider. In other embodiments, the selected media provide may receive custom licensing options proposed by the media requestor and the media provider may agree for a specified fee, respond with a counter proposal of licensing options for a fee, or decline the assignment. In certain embodiments, the licensing options may include one or more restrictions on the custom media to be generated including, for example, restrictions on the duration (e.g., time limited or perpetual), geography (e.g., city, state, or country), type of use (e.g., editorial or creative), type of media (e.g., broadcast, online, or print), and type of exclusivity (e.g., non-exclusive or exclusive). In other embodiments, the licensing options may include predetermined restrictions on the custom media to be generated including, for example, royalty-free, rights-ready, and rights-managed, that correspond to common license terms used in the industry. In still other embodiments, the licensing options may include a custom commissioned licensing scheme where the media requestor may select the license terms, subject to the selected media provider's consent, for the custom media to be generated.

Continuing, FIG. 2E shows a graphical user interface of a client-side software application, or web-based portal thereof, 400 for engaging the selected content provider in accordance with one or more embodiments of the present invention. Once the media requestor has decided to proceed with a selected media provider, the client-side software application may provide a summary display 445 of the request for custom media to be generated. The media requestor may enter, confirm, or modify information pertaining to the request including, for example, one or more of the service location of interest, the time the custom media is to be generated, the date the custom media is to be generated, information relating to the type or kind of custom media to be generated, and licensing terms. The media requestor may also have the option to provide custom instructions 450 to the selected media provider regarding the custom media to be generated. Once the media requestor has entered and confirmed the choices, the media requestor may submit the assignment request to the selected media provider by way of the server-side software application.

FIG. 2F shows a graphical user interface of a provider-side software application, or web-based portal thereof, 500 for reviewing an assignment request and confirming the engagement in accordance with one or more embodiments of the present invention. The server-side software application may provide the provider-side software application, or web-based portal thereof, with a notification of an incoming request for custom media from a prospective client. The notification may include information pertaining to the request including, for example, one or more of the service location of interest, the time the custom media is to be generated, the date the custom media is to be generated, information relating to the type or kind of custom media to be generated, and licensing terms. The notification may include custom instructions 515 from the media requestor. The media provider may optionally provide comments 520 to the media requestor. If the media provider wishes to accept with the assignment, the media provider may signify his acceptance of the assignment and confirm the engagement with the media requestor by way of the server-side software application. In certain embodiments, the acceptance may include binding acceptance of the licensing terms.

Continuing, FIG. 2G shows a graphical user interface of a client-side software application, or web-based portal thereof, 400 for confirming the selected media provider's acceptance of the assignment and engagement in accordance with one or more embodiments of the present invention. The server-side software application may confirm the selected media provider's acceptance of the assignment 470 and may include optional comments 460 from the selected media provider. Continuing, FIG. 2H shows a simplified block diagram of a system 100 for generating custom real-time media on demand where the selected content provider 300g provides custom media to the media requestor 110c in accordance with one or more embodiments of the present invention. Once the request has been transmitted and accepted, the media provider has agreed to generate the custom media in accordance with the media requestor's request. In requests for real-time generation of custom media, the selected media provider may immediately begin transmitting the requested media. In certain embodiments, the media provider may transmit the requested custom media to the media requestor via a sideband peer-to-peer network connection 130 facilitated by the server-side software application. In other embodiments, the media provider may transmit the requested custom media to the server-side software application via a network connection and the server-side software application may transmit the requested custom media to the media requestor in real time or at a later time on demand.

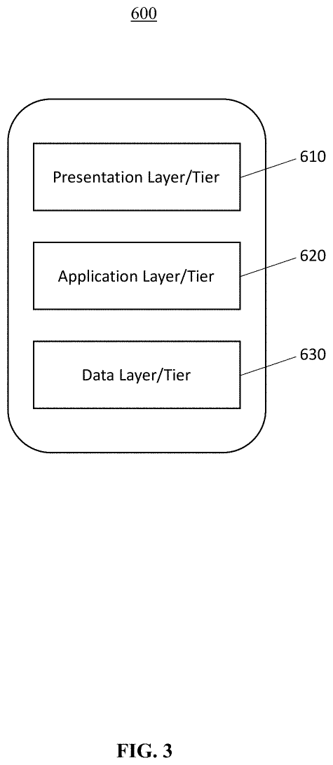

FIG. 3 shows a block diagram of a server-side software application 600 as part of a system for generating custom real-time media on demand in accordance with one or more embodiments of the present invention. The server-side software application 600 may include a presentation layer or tier 610, an application layer or tier 620, and a data layer or tier 630. One of ordinary skill in the art will recognize that in the software arts the term layers refer to logical separation of software components whereas the term tiers refer to the physical separation of software components. As such, depending on the particular application or design, server-side software application 600, and the components and features thereof, may be partitioned into one or more logical layers and/or one or more physical tiers. From a functional standpoint, the presentation layer or tier 610 may generally be responsible for the user interfaces, the application layer or tier 620 may generally be responsible for the application logic, and the data layer or tier 630 may generally manage data stores and data access.

In one or more embodiments of the present invention, a server-side software application 600 may perform a method of generating custom real-time media on demand. On an ongoing basis, the presentation layer or tier 610 may receive location information for available media providers that the application layer or tier 620 stores in the data layer or tier 630 and continuously, periodically, or at least occasionally updates. In this way, the server-side software application 600 maintains a data store of available media providers and their current or at least last reported locations. The locations of the media providers may be provided by location services of the smartphones, self-reported, or generated based on available information including, for example, one or more of GPS signals, network identification, cell of origin, lateration techniques, angulation techniques, location patterning as well as signal strength, Wi-Fi access point identification, Wi-Fi signal strength to identifiable access points, Wi-Fi triangulation, Bluetooth, Near-Field Communication, and any other suitable means of identifying the current location of available media providers.

The method may include receiving, from a media requestor, via the presentation layer or tier 610, a request for custom media to be generated at or near a service location of interest. As a preliminary matter, the application tier or later 620 of the server-side software application 600 may optionally exclude certain predetermined locations from serving as a service location. For example, the server-side software application 600 may restrict predetermined locations that are government restricted, on private land without right of entry, or otherwise pose a risk to media providers. The application layer or tier 620 of the server-side software application 600 may determine available media providers located at or near the service location of interest and potentially within a predetermined radius of the service location of interest by querying the data store of available media providers and their respective locations in the data layer or tier 630. The application layer or tier 620 of the server-side software application 600 may determine service capabilities for the available media providers located at or near the service location and store the date in the data layer or tier 630. The application layer or tier 620 of the server-side software application 600 may provide the client-side software application information corresponding to the available media providers via the presentation layer or tier 610. The media requestor may browse the map-based graphical user interface of the client-side software application and select a specific media provider from the available media providers located at or near the service location.

The server-side software application 600 may provide the media requestor with one or more licensing options for the custom media to be generated. In certain embodiments, the licensing options may include predetermined licensing options offered by the selected media provider. For example, custom commissioned, royalty-free, rights-ready, and rights managed, that are commonly used in the industry. In other embodiments, the licensing options may include custom licensing options proposed by the media requestor, where the selected media provider may agree to the custom licensing options proposed for a fee, respond with a counter proposal for a fee, or decline the assignment. In all embodiments, the licensing options may include one or more restrictions on the custom media to be generated including duration of use, geographic restrictions, type of use restrictions, type of media restrictions, and type of exclusivity, such as, for example, exclusive and non-exclusive. The presentation layer or tier 610 of the server-side software application 600 may receive the media requestor's selection of a media provider from the available media providers from the client-side software application. The request may include a media requestor's selection of licensing options for the custom media to be generated. Once received, the application layer or tier 620 of the server-side software application may facilitate the provision, directly or indirectly, of the custom media from the selected media provider to the media requestor in real-time.

In certain embodiments, the custom media may be provided from the selected media provider to the media requestor directly via a sideband peer-to-peer network connection facilitated by the server-side software application 600. In other embodiments, the custom media may be provided from the selected media provider to the media requestor indirectly via the server-side software application 600. In such embodiments, the selected media provider establishes a network connection with the server-side software application 600 and transmits the requested custom media to the server-side software application 600. The server-side software application 600 may forwards the custom media to the client-side software application, wait for the client-side software application to request the custom media, or store the custom media off-line for a later time or on-demand retrieval.

While the selected media provider is generating and transmitting the custom media to the media requestor, the media requestor may optionally transmit, directly or indirectly, real-time directives or instructions relating to the production of the custom media. Similarly, the selected media provider may optionally transmit, directly or indirectly, real-time questions to the media requestor. Other than sideband communication between the selected media provider and the media requestor, the media requestor interacts with the presentation layer or tier 610 of the server-side software application 600 through the graphical user interface of the client-side software application. Similarly, other than sideband communication between the selected media provider and the media requestor, all media providers interact with the presentation layer or tier 610 of the server-side software application 600.

In one or more embodiments, a non-transitory computer readable medium, comprising software instructions that, when executed by a processor, perform the above-noted method of generating custom real-time media on demand. The computer readable medium comprising the server-side software application 600 may be executed on the one or more computing resources, or servers (e.g., 200 of FIG. 1).

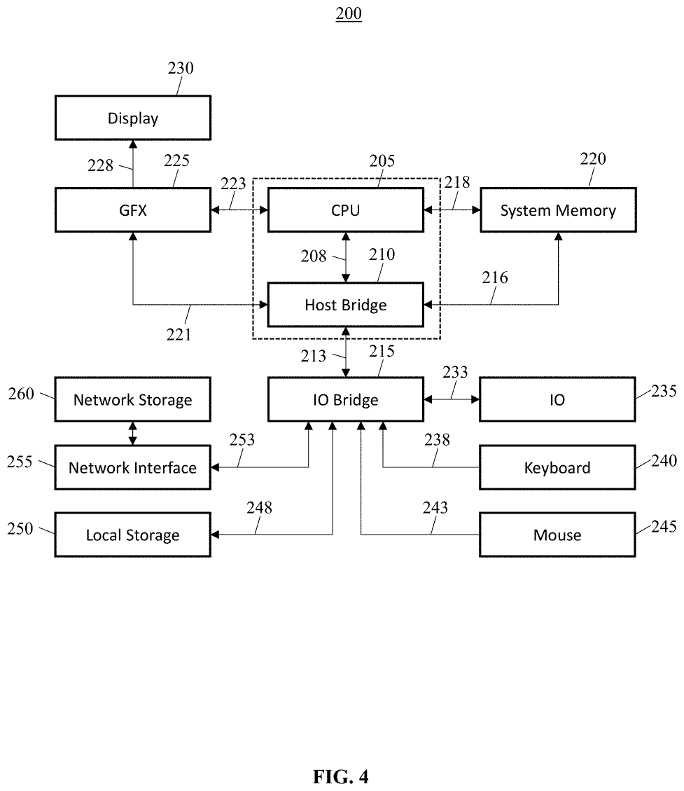

FIG. 4 shows a block diagram of an exemplary computing system 200 as part of a system (e.g., 100 of FIG. 1) in accordance with one or more embodiments of the present invention. The exemplary computing system 200 may correspond to one or more server-side computing systems 200 and may potentially correspond to one or more client-side computing systems (e.g., 110 of FIG. 1) or provider-side computing systems (e.g., 300 of FIG. 1). The method of generating custom real-time content on demand may be executed by such a computing system 200 or well-known variations thereof. For example, one or more of the client-side software application, or web-based portal thereof, the server-side software application, or the provider-side software application, or web-based portal thereof, may be software applications that, when executed by a processor of such a computing system (e.g., 110, 200, or 300 of FIG. 1), perform the methods disclosed herein. One of ordinary skill in the art will recognize that computing system 200 disclosed herein is merely exemplary of a type or kind of computing system that may be used to execute any of the above-noted software applications and other computing systems well known in the art may be used in accordance with one or more embodiments of the present invention.

Computing system 200 may include one or more central processing units, sometimes referred to as processors (hereinafter referred to in the singular as “CPU” or plural as “CPUs”) 205, host bridge 210, input/output (“IO”) bridge 215, graphics processing units (singular “GPU” or plural “GPUs”) 225, and/or application-specific integrated circuits (singular “ASIC” or plural “ASICs”) (not shown) disposed on one or more printed circuit boards (not shown) that perform computational operations. Each of the one or more CPUs 205, GPUs 225, or ASICs (not shown) may be a single-core (not independently illustrated) device or a multi-core (not independently illustrated) device. Multi-core devices typically include a plurality of cores (not shown) disposed on the same physical die (not shown) or a plurality of cores (not shown) disposed on multiple die (not shown) that are collectively disposed within the same mechanical package (not shown).

CPU 205 may be a general-purpose computational device typically configured to execute software instructions. CPU 205 may include an interface 208 to host bridge 210, an interface 218 to system memory 220, and an interface 223 to one or more IO devices, such as, for example, one or more GPUs 225. GPU 225 may serve as a specialized computational device typically configured to perform graphics functions related to frame buffer manipulation. However, one of ordinary skill in the art will recognize that GPU 225 may be used to perform non-graphics related functions that are computationally intensive. In certain embodiments, GPU 225 may interface 223 directly with CPU 205 (and interface 218 with system memory 220 through CPU 205). In other embodiments, GPU 225 may interface 221 with host bridge 210 (and interface 216 or 218 with system memory 220 through host bridge 210 or CPU 205 depending on the application or design). In still other embodiments, GPU 225 may interface 233 with IO bridge 215 (and interface 216 or 218 with system memory 220 through host bridge 210 or CPU 205 depending on the application or design). The functionality of GPU 225 may be integrated, in whole or in part, with CPU 205.

Host bridge 210 may be an interface device that interfaces between the one or more computational devices and IO bridge 215 and, in some embodiments, system memory 220. Host bridge 210 may include an interface 208 to CPU 205, an interface 213 to IO bridge 815, for embodiments where CPU 205 does not include an interface 218 to system memory 220, an interface 216 to system memory 220, and for embodiments where CPU 205 does not include an integrated GPU 225 or an interface 223 to GPU 225, an interface 221 to GPU 225. The functionality of host bridge 210 may be integrated, in whole or in part, with CPU 205. IO bridge 215 may be an interface device that interfaces between the one or more computational devices and various IO devices (e.g., 240, 245) and IO expansion, or add-on, devices (not independently illustrated). IO bridge 215 may include an interface 213 to host bridge 210, one or more interfaces 233 to one or more IO expansion devices 235, an interface 238 to keyboard 240, an interface 243 to mouse 245, an interface 248 to one or more local storage devices 250, and an interface 253 to one or more network interface devices 255. The functionality of IO bridge 215 may be integrated, in whole or in part, with CPU 205 and/or host bridge 210. Each local storage device 250, if any, may be a solid-state memory device, a solid-state memory device array, a hard disk drive, a hard disk drive array, or any other non-transitory computer readable medium. Network interface device 255 may provide one or more network interfaces including any network protocol suitable to facilitate networked communications.

Computing system 200 may include one or more network-attached storage devices 260 in addition to, or instead of, one or more local storage devices 250. Each network-attached storage device 260, if any, may be a solid-state memory device, a solid-state memory device array, a hard disk drive, a hard disk drive array, or any other non-transitory computer readable medium. Network-attached storage device 260 may or may not be collocated with computing system 200 and may be accessible to the computing system (e.g., 110, 200, or 300 of FIG. 1) via one or more network interfaces provided by one or more network interface devices 255.

One of ordinary skill in the art will recognize that computing system 200 may be a conventional computing system or an application-specific computing system (not shown). In certain embodiments, an application-specific computing system (not shown) may include one or more ASICs (not shown) that perform one or more specialized functions in a more efficient manner. The one or more ASICs (not shown) may interface directly with CPU 205, host bridge 210, or GPU 225 or interface through IO bridge 215. Alternatively, in other embodiments, an application-specific computing system (not shown) may be reduced to only those components necessary to perform a desired function in an effort to reduce one or more of chip count, printed circuit board footprint, thermal design power, and power consumption. The one or more ASICs (not shown) may be used instead of one or more of CPU 205, host bridge 210, IO bridge 215, or GPU 225. In such systems, the one or more ASICs may incorporate sufficient functionality to perform certain network and computational functions in a minimal footprint with substantially fewer component devices.

As such, one of ordinary skill in the art will recognize that CPU 205, host bridge 210, IO bridge 215, GPU 225, or ASIC (not shown) or a subset, superset, or combination of functions or features thereof, may be integrated, distributed, or excluded, in whole or in part, based on an application, design, or form factor in accordance with one or more embodiments of the present invention. Thus, the description of computing system 200 is merely exemplary and not intended to limit the type, kind, or configuration of component devices that constitute a computing system 200 suitable for executing software methods in accordance with one or more embodiments of the present invention. Notwithstanding the above, one of ordinary skill in the art will recognize that computing system 200 may be a standalone, laptop, desktop, industrial, server, blade, or rack mountable system and may vary based on an application or design.

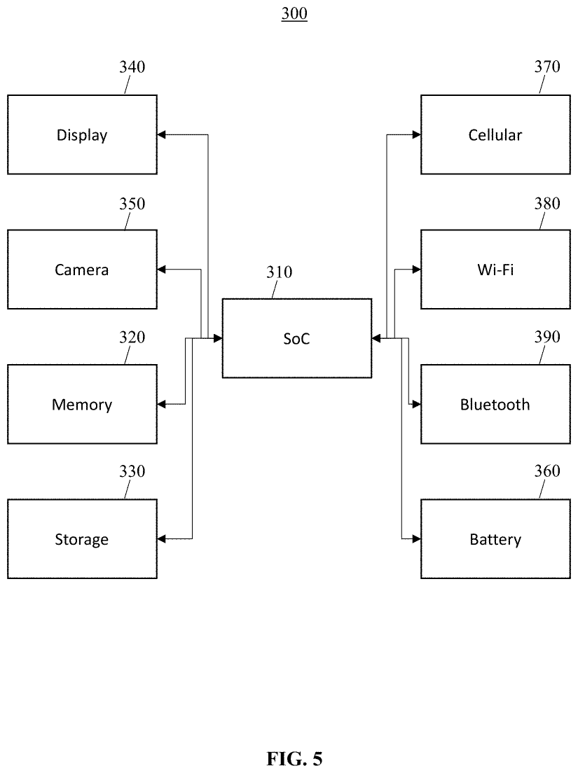

FIG. 5 shows a block diagram of an exemplary smartphone 300 in accordance with one or more embodiments of the present invention. Modern smartphones 300 are exceptionally valuable to the methods disclosed herein due to the fact that smartphones 300 include hardware and software that enables high equality the creation of high quality video, audio, and photographic media, and include hardware and software that enable a large number of network communication protocols including cellular, Wi-Fi, Bluetooth, Near Field Communications, as well as others. Moreover, smartphones 300 include hardware and software that enables the accurate determination of their location. The operating systems of modern smartphones 300 include what is referred to in the industry as location services. Location services are a suite of tools that allow the operating system to determine and enhance the accuracy of the determination of the location of the smartphone 300. As such, smartphones 300 may play an important role in the method of generating custom real-time media on demand. For example, because most smartphones 300 include high resolution cameras, every person carrying a smartphone on their person may potentially serve as a media provider, enabling everyone with a smartphone 300 to break news on demand in real-time. Further, the location services inherent in the smartphone 300 facilitates the determination of their location relative to the service location of interest. Similarly, smartphones 300 may be useful to the client media requestor in that, the touch screen interface of most smartphones 300 facilitates browsing the map-based graphical user interface used to specify a service location of interest and select a media provider to provide the custom media to be generated.

Smartphone 300 may include a system-on-chip (“Sort”) 310 that integrates one or more processing cores (not shown), one or more graphics processing cores (not shown), network functionality, and battery management, and potentially other features capable of being integrated in a small and typically low power device suitable for use in smartphones. Smartphone 300 may include system memory 320, local storage 330, an integrated touchscreen-based display 340, and an integrated high resolution camera capable of recording video, audio, and photographic media. Smartphone 300 may also include a battery 360, a cellular network interface and a Wi-Fi network interface 380. Smartphone 380 may also include one or more short range network interfaces including, for example, a Bluetooth 390 interface, and a Near-Field Communications interface (not shown).

Advantages of one or more embodiments of the present invention may include one or more of the following:

In one or more embodiments of the present invention, a method of generating custom real-time media provides a media requestor with access to media providers around the world that are capable of providing custom real-time media on demand.

In one or more embodiments of the present invention, a method of generating custom real-time media allows a media requestor to identify available media providers located at or near a service location of interest and facilitates the provision of custom media from the selected media provider to the media requestor in real-time.

In one or more embodiments of the present invention, a method of generating custom real-time media allows a media requestor to influence or control the production of the requested custom media to be generated.

In one or more embodiments of the present invention, a method of generating custom real-time media allows the media requestor to transmit real-time directives from the media requestor to the selected media provider shortly before or while the selected media provider is transmitting the custom media.

In one or more embodiments of the present invention, a method of generating custom real-time media allows the selected media provider to transmit real-time questions from the selected media provider to the media requestor shortly before or while the selected media provider is transmitting the custom media.

In one or more embodiments of the present invention, a method of generating custom real-time media facilitates licensing of the requested custom media from the selected media provider to the media requestor.

In one or more embodiments of the present invention, a method of generating custom real-time media guarantees that the media requestor will receive requested custom media in accordance with pre-negotiated license terms.

In one or more embodiments of the present invention, a method of generating custom real-time media may be used to enhance an independent media agency.

In one or more embodiments of the present invention, a method of generating custom real-time media may be used to enhance syndication.

In one or more embodiments of the present invention, a method of generating custom real-time media may be used as part of a social network.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of custom real-time media on demand comprising:
receiving, at a server-side software application, a request for custom media to be generated in real-time at or near a service location that is specified by a media requestor via a client-side software application;
determining, at the server-side software application, available media providers that are located at or near the specified service location, wherein the available media providers provide the server-side software application their current location via a provider-side software application;
providing, from the server-side software application to the client-side software application, information relating to the available media providers located at or near the media requestor's specified service location;
receiving, at the server-side software application, the media requestor's selection of a media provider selected from the available media providers, wherein the media requestor provides the selection from the client-side software application;
facilitating direct transmission of the custom media from the selected media provider to the media requestor; and
while the custom media is being transmitted, receiving, at the server-side software application, real-time directives from the media requestor, via the client-side software application, and providing the selected media provider, via the provider-side software application, the real-time directives from the media requestor,
wherein the custom media is transmitted directly from the selected media provider, via the provider-side software application, to the media requestor, via the client-side software application, by way of a sideband peer-to-peer network that does not require communications between the server-side software application and the client-side software application or between the server-side software application and the provider-side software application to transmit the custom media.

2. The method of claim 1, further comprising:
receiving, at the server-side software application, location information for available media providers located at or near the service location from each available media provider's instance of the provider-side software application.

3. The method of claim 1, further comprising:
determining, at the server-side software application, service capabilities for available media providers located at or near the service location provided by each available media provider's instance of the provider-side software application.

4. The method of claim 1, further comprising:
receiving, at the server-side software application, real-time questions from the selected media provider, via the provider-side software application, and providing the media requestor, via the client-side software application, the real-time questions.

5. The method of claim 1, further comprising:
excluding, on the server-side software application, predetermined locations from being designated the specified service location;

6. The method of claim 1, wherein the service location comprises an address, an intersection, a zip code, a point of interest, GPS coordinates, or latitude and longitude.

7. The method of claim 1, wherein the custom media comprises one or more of video, audio, or photographic content.

8. The method of claim 1, wherein the request for custom media comprises one or more of a date, time, location, and type of custom media requested by the media requestor.

9. The method of claim 1, wherein the custom media is provided from the selected media provider to the media requestor in substantially real-time.
